(19) United States
(12) Patent Application Publication
(10) Pub. No.: US 2013/0204672 A1
(43) Pub. Date: Aug. 8, 2013

(54) COMPENSATION SYSTEMS AND METHODS FOR A NETWORK MARKETING ORGANIZATION

(71) Applicant: Melyn Campbell, Salt Lake City, UT (US)

(72) Inventor: Melyn Campbell, Salt Lake City, UT (US)

(21) Appl. No.: 13/762,313

(22) Filed: Feb. 7, 2013

Related U.S. Application Data
(60) Provisional application No. 61/596,322, filed on Feb. 8, 2012.

(51) Int. Cl. G06Q 10/06

(52) U.S. Cl. CPC G06Q 10/06393
USPC 705/7.39

(57) ABSTRACT

A method for compensating distributors in a network marketing system is disclosed. The method includes compensating a distributor based on a progressive pay compensation plan in which the distributor is paid a percentage of PV in the distributor's downline when the quantity of PV of the distributor and the distributor's downline reach a set of predetermined thresholds.

### CROSS-REFERENCE TO RELATED APPLICATIONS

This application claims the benefit of U.S. Provisional Application No. 61/596,322, filed Feb. 8, 2012.

### BACKGROUND

1. Field of the Invention

This application relates generally to business methods and compensation systems and methods. More specifically, this application relates to compensation systems and methods for network marketing business models involved in the sale of multiple products or product lines.

2. Background

Network marketing, also known as multi-level marketing (MLM), is a business model that combines direct retail marketing with a sales force of independent contractors. Network marketing is an alternate channel to traditional store-based retail sales and marketing. Network marketing businesses usually function by enrolling unsalaried salespeople, also known in the business as independent distributors, independent business owners, sales consultants, etc., (hereinafter “distributors”) to sell products. Distributors may earn additional sales commissions based on the sales of people recruited into their downline. A distributor's downline includes the distributor's direct recruits, recruits' recruits and so on such that there may be multiple levels of people receiving commissions from one person's sales.

Network marketing offers several advantages over the other retail channels such as low advertising overhead. Unlike a typical retail company, the network marketing company does not have to spend large amounts of money to obtain customers. Instead, the company can pay distributors to expose and promote the product out into the marketplace. In return, the company pays the distributors a percentage commission on products actually sold. In some traditional network marketing organizations, distributors are rewarded for the sales they create, not only directly, but indirectly as well. Distributors may earn profit from any retail sales they make plus a bonus or override on the sales made by people in their downline. By getting a percent from many people, an individual distributor's income can grow very large.

A problem with single product network marketing companies is the challenge of expanding its product offerings to include additional products or product lines. This process can frequently cause a decrease in sales volume of the initial product category. In these instances, when the new product is released, true incremental volume is not necessarily achieved.

Systems and methods are herein presented for overcoming these challenges.

### SUMMARY

This present invention relates generally to business methods and compensation systems and methods that can overcome the problems faced by single-product network marketing companies. More specifically, this present invention relates to compensation systems and methods for network marketing business models that can facilitate the introduction of products and product lines into a network marketing organization while increasing overall sales volumes. Accordingly, the compensation systems and methods can compensate distributors in a network marketing system based on a progressive pay compensation plan. In this plan, the distributor can be paid a percentage of personal volume (PV) in the distributor's downline when the quantity of PV of the distributor and/or the distributor's downline reaches a set of predetermined thresholds. Such a plan can reduce the likelihood of a decrease in the sales volume of an initial product category when further product categories are introduced.

In some implementations of the invention, the compensation method is performed by a computer system with at least one processor and at least one non-transitory computer readable medium encoded with program instructions that, when executed, cause the computer system to perform the compensation. The method can involve identifying, by the at least one processor, and compensating a distributor for PV of individual members of the distributor's downline that amount to at least a first volume when the distributor has PV of at least the first volume. For example, the distributor can be paid a percentage of each PV of a downline distributor if the PV of the individual downline distributor exceeds a number, such as fifty PV.

The method can further involve identifying, by the at least one processor, and compensating the distributor for PV of individual members in the distributor's downline of a particular product when the distributor has PV of the particular product of at least a second volume. Generally, the PV of the distributor and members in the distributor's downline counted in the first volume are not counted in the second volume. For example, if a distributor has one hundred PV in a product category, not including the initial first volume (the first fifty PV in the previous example), the distributor can be paid a percentage of each PV of that product in his/her downline that are not included in the first volumes.

Some implementations of the compensation method further include identifying, by the at least one processor, and compensating the distributor for PV in the product category of members in the distributor's downline when the entire volume of PV of the product category of members in the distributor's downline exceeds a third volume. The third volume can be, for instance, one thousand PV. Thus, for example, if the entire PV volume of a distributor's frontline, not including the first set of PV, exceeds one thousand PV, the distributor may be paid a percentage or additional percentage of each of these one thousand PV. In some instances, this percentage is about ten percent. In some instances, the PV of each member in the distributor's downline do not include the downline of executive distributors in the distributor's downline.

Some implementations of the compensation method may include further identifying, by the at least one processor, and compensating the distributor based on the ratio of PV attributable to the distributor over entire company PV of the network marketing organization. The PV attributable to the distributor can include the entire volume of PV of the product category of the distributor and members in the distributor's downline that are not counted in the first volume. In some instances, the entire volume can include the PV of the downline of an executive distributor in the distributor's downline.

Further embodiments of the present invention are described in the Detailed Description section below.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings.

FIG. 1 illustrates a representative distributor downline, according to some embodiments of the invention.

FIG. 2 illustrates a block diagram of progressive pay portals or thresholds, according to some embodiments of the invention.

FIG. 3 illustrates a block diagram representing progressive pay portals in a distributor's downline, according to some embodiments of the invention.

FIG. 4 illustrates a block diagram representing another set of progressive pay portals in a distributor's downline, according to some embodiments of the invention

FIG. 5 illustrates a block diagram representing yet another set of progressive pay portals in a distributor's downline.

FIG. 6 illustrates a representative system for implementing embodiments of the invention.

FIG. 7 illustrates a representative networked system configuration that may be used in association with embodiments of the present invention.

### DETAILED DESCRIPTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The following disclosure of the present invention may be grouped into subheadings. The utilization of the subheadings is for convenience of the reader only and is not to be construed as limiting in any sense.

The description may use perspective-based descriptions such as up/down, back/front, left/right and top/bottom. Such descriptions are merely used to facilitate the discussion and are not intended to restrict the application or embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB)”, that is, A is an optional element.

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in various embodiments,” which may each refer to one or more of the same or different embodiments. Furthermore, the terms “comprising,” “including,” “having,” and the like, as used with respect to embodiments of the present invention, are synonymous with the definition afforded the term “comprising.”

This present invention relates generally to business methods and compensation systems and methods that can overcome the problems faced by single-product network marketing companies. More specifically, this present invention relates to compensation systems and methods for network marketing business models that can facilitate the introduction of products and product lines into a network marketing organization while increasing overall sales volumes. Accordingly, the compensation systems and methods can compensate distributors in a network marketing system based on a progressive pay compensation plan. In this plan, the distributor can be paid a percentage of PV in the distributor's downline when the quantity of PV of the distributor and/or the distributor's downline reaches a set of predetermined thresholds. Such plan can reduce the likelihood of a decrease in the sales volume of an initial product category when further product categories are introduced.

In some implementations of the invention, the compensation method is performed by a computer system with at least one processor and at least one non-transitory computer readable medium encoded with program instructions that, when executed, cause the computer system to perform the compensation. The method can involve identifying, by the at least one processor, and compensating a distributor for PV of individual members of the distributor's downline that amount to at least a first volume when the distributor has PV of at least the first volume. For example, the distributor can be paid a percentage of each PV of a downline distributor if the PV of the individual downline distributor exceeds a number, such as fifty PV.

The method can further involve identifying, by the at least one processor, and compensating the distributor for PV of individual members in the distributor's downline of a particular product when the distributor has PV of the particular product of at least a second volume. Generally, the PV of the distributor and members in the distributor's downline counted in the first volume are not counted in the second volume. For example, if a distributor has one hundred PV in a product category, not including the initial first volume (the first fifty PV in the previous example), the distributor can be paid a percentage of each PV of that product in his/her downline that are not included in the first volumes.

Some implementations of the compensation method further include identifying, by the at least one processor, and compensating the distributor for PV in the product category of members in the distributor's downline when the entire volume of PV of the product category of members in the distributor's downline exceeds a third volume. The third volume can be, for instance, one thousand PV. Thus, for example, if the entire PV volume of a distributor's frontline, not including the first set of PV, exceeds one thousand PV, the distributor may be paid a percentage or additional percentage of each of these one thousand PV. In some instances, this percentage is about ten percent. In some instances, the PV of each member in the distributor's downline do not include the downline of executive distributors in the distributor's downline.

Some implementations of the compensation method may include further identifying, by the at least one processor, and compensating the distributor based on the ratio of PV attributable to the distributor over entire company PV of the network marketing organization. The PV attributable to the distributor can include the entire volume of PV of the product category of the distributor and members in the distributor's downline that are not counted in the first volume. In some instances, the entire volume can include the PV of the downline of an executive distributor in the distributor's downline.

Further embodiments of the present invention will be described in the Compensation Systems and Methods subsection and depicted in the Drawings.

### Compensation Systems and Methods

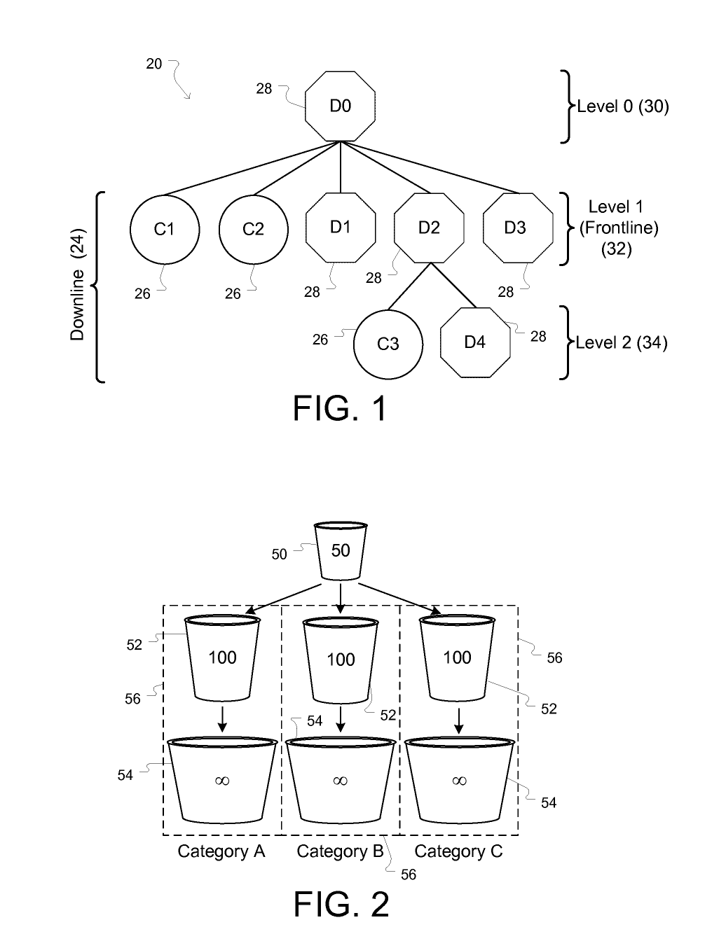

Reference will first be made to FIG. 1, which illustrates a representative network marketing organization 20. FIG. 1 depicts a network marketing organization 20 that has five distributors 28 and three customers 26. For illustration purposes, the customers C1-C3 26 are depicted as circles, and distributors D0-D4 28 are depicted as octagons. It will be understood, that other embodiments can include more members in the network marketing organization 20 than are depicted in FIG. 1. For example, some network marketing organizations 20 can include hundreds or thousands of members, multiple distributors 28 in Level 0 (30), and many levels, such as up to dozens, hundreds, or thousands of levels in the respective downlines 24.

As mentioned, network marketing is a business model that combines direct retail marketing with a sales force of independent contractors. Network marketing is an alternate channel to traditional store-based retail sales and marketing. Network marketing businesses usually function by enrolling unsalaried distributors 28 to sell products. Distributors 28 may earn additional sales commissions based on the sales of people recruited into their downline 24. A distributor's downline 24 includes the distributor's direct recruits, recruits' recruits and so on such that there may be multiple levels 30, 32, 34 of people receiving commissions from one person's sales. Thus, as a distributor's downline 24 grows, the distributor 28 has increased earning abilities.

Accordingly, as shown in FIG. 1, a primary distributor, D0, 22 has recruited two customers C1 and C2 into his/her front line 32. In some embodiments, customers recruited by a distributor 28 can be located on the recruiting distributor's frontline 24, as shown. Distributor D0 (28) has also recruited three distributors D1-D3 (28) into his front line 32. Downline distributor D2 (28) has also recruited customer C3 (26) and distributor D4 (28) into his front line, which is Level 2 (34) of D0's downline 24.

Customers 26 can be individuals who buy products through a recruiting distributor 22, 28. Some customers 26 can be retail customers who buy products with or without a purchasing commitment or quota. Enrolling distributors can get a retail markup plus commissions on products sold to customers. Other customers can be preferred customer who purchase products on a subscription basis in return for a product price without the retain markup. Some preferred customers may be auto-ship customers, which automatically purchase and receive a certain amount of product from the network marketing organization 20 monthly, quarterly, annually or otherwise periodically.

In some embodiments, when customers 26 and/or distributors 28 purchase products from the network marketing organization 20, the purchases are made through the recruiting distributor 22 and/or are attributed to the recruiting distributor. Thus, a compensation system of the network marketing organization 20 can be configured to recognize who purchased each product, and where the purchaser is positioned in the network marketing organization 20. In this way, the appropriate upline distributor(s) 28 can be identified, credited, and ultimately compensated for purchases made by distributors 28 and customers 26 in his or her downline 24.

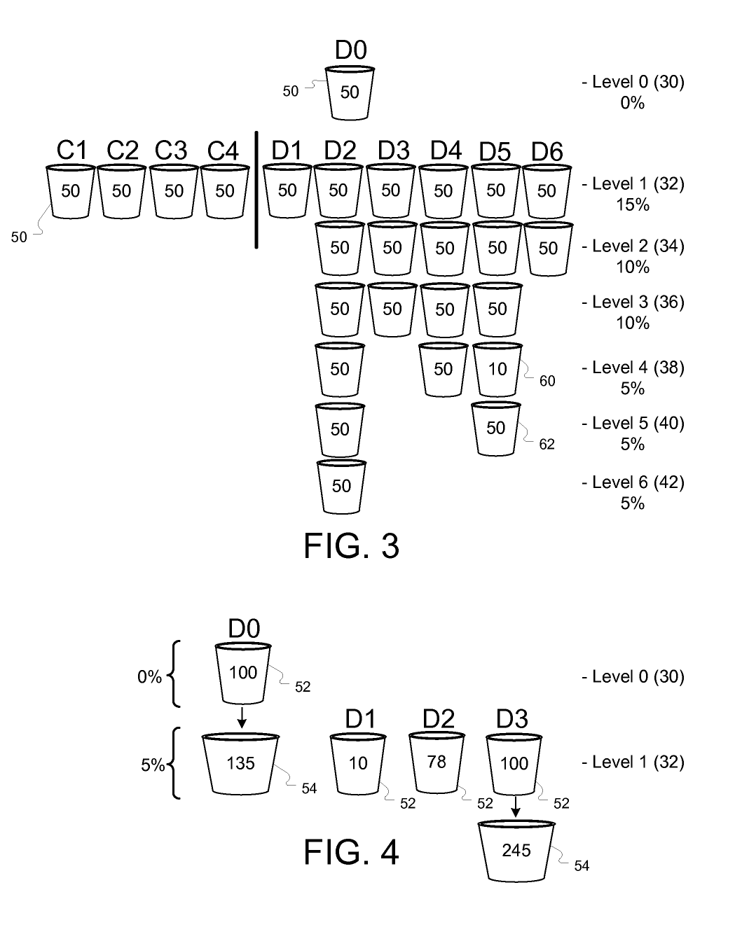

FIG. 2 illustrates a block diagram of some aspects of representative compensation systems, whereby distributors 28 are compensated based on sales of made by the sales activities of qualifying members of his/her downline 24. Generally, the compensation system includes two parts. In the first part, which can be referred to as a unilevel part, a distributor 28 is compensated for a first set of sales of any product or product category made by members, including both customers 26 and distributors 28, in a distributor's downline 24. This unilevel part is attained when the distributor 28 and/or members in the distributor's downline have personal volumes of at least a first volume. This may be referred to as a first volume requirement. In addition, herein products ordered, sold, or purchased by a distributor 28 or customer 26 will be referred to as personal volume or PV. In some instances, each distributor 28 must have a PV of at least the first volume in order to meet the first volume requirement and qualify for the unilevel part of the compensation system. This first volume requirement may be required during a single compensation period. The compensation period can be a single week, a month, two months, three months, four months, six months, a year, etc. Hereafter, the compensation period of a single month will be used for illustration purposes. Generally, the compensation paid to the distributor in this first, unilevel part is a percentage of the price of the PV of first set made by members of a distributor's downline, not by the distributor himself/herself. This will be described in detail in relation to FIG. 3. The price of the PV can be the wholesale price, retail price, or another fixed price for each product. The price can also be determined by the nature of the buyer, be it a distributor, retail customer, or preferred customer.

In some instances, the first volume requirement is relatively low, offering a relatively low entry-level purchasing requirement to distributors 28, such as new or part-time distributors 28. For instance, the first volume can be between about 5 and about 500, including ranges therebetween, such as about 5 to about 25, about 25 to about 50, about 50 to about 100, about 100 to about 250, about 250 to about 500, etc. In some instances, the first volume is about 50 PV. The representative number 50 PV as a first volume will be utilized herein for non-limiting illustration purposes.

Accordingly, FIG. 2 illustrates a first bucket 50 that represents the requirement of the first 50 PV meeting the first volume requirement. After meeting this requirement, a distributor 28 is entitled to compensation from the first part of the compensation system and can begin to qualify for compensation from the second part of the compensation system. Thus, for the purpose of illustration, PV can be viewed filling up a sequence of buckets that progressively are filled as a distributor 28 and members of the distributor's downline 24 purchase products during a month. As each bucket is filled with a preset amount of PV (set by a volume requirement), the spillover PV goes to the next bucket. Each filled bucket qualifies the distributor 28 for another part of the compensation. In other terms, the buckets can be viewed as pay portals, which entitle a distributor 28 to enter another part of the compensation system after filling the bucket with sales.

Referring still to FIG. 2, in the second general part of the compensation system, a distributor 28 is compensated PV of members in the distributor's downline 24 of a specific product category 56 above those counted in the first volume, such as, the first 50 PV. A unique feature of the compensation system is the division of the compensation system into product categories 56 for purposes of evaluating PV achievement levels for compensation purposes. Thus, the compensation system is designed to motivate sales activity and distributor activity across multiple products and/or product categories 56 by conditioning compensation levels on achieving certain performance levels not just generally, but within each category 56. Thus, FIG. 2 illustrates compensation above the first general part of the compensation system according to various categories 56 being dependent on categorical sales of products, not overall sales. Of course, the separation of compensation requirements by category can occur at any stage of the process, such as at the first volume stage, or at any subsequent stage. Regardless of the stage at which the separation occurs, each order or sale can be evaluated to determine and assign for compensation purposes the specific product category 56 of each portion of the order.

Each distributor 28 may qualify for this second part of the compensation system by achieving a PV in the specific product category 56 (which can include only a single product or a selected group of products) of at least a second volume. This may be referred to as a second volume requirement. This second volume may not include PV counted in the first volume for the first part of the compensation system. Once a distributor 28 qualifies for this second part of the compensation system for a specific product category 56, the distributor 28 may be paid a percentage of the price of each PV of the products in the product categories 56 sold in the second volume by members in the distributor's downline 24. PV counted in the second volume may exclude PV counted in the first volume (e.g., the first 50) for the first part of the compensation system. The percentages paid in this second part of the compensation system will be described in detail in relation to FIG. 3.

In some instances, the second volume requirement is higher than the first volume requirement. In other instances, the second volume is the same or lower than the first volume. For example, the second volume can be between about 10 PV and about 1000 PV, including ranges therebetween, such as about 10 PV to about 25 PV, about 25 PV to about 50 PV, about 50 PV to about 100 PV, about 100 PV to about 250 PV, about 250 PV to about 500 PV, about 500 PV to about 1000 PV, etc. In some instances, the second volume is about 100 PV. The representative number 100 PV as a second volume will be utilized herein for non-limiting illustration purposes.

As further shown in FIG. 2, after a distributor 28 has enough sales to fill the second volume requirement, or the second bucket 52 (shown as a 100 bucket), all additional sales can spill over into an overflow bucket 54. This overflow bucket 54 is shown as an infinity “∞” bucket since it does not overflow in to another bucket or open another pay portal. Rather, sales filling the overflow bucket 54 are compensated with the second part of the compensation system.

As mentioned, the second part of the compensation system separates the compensation for each distributor based on the categories 56 of the PV made by the distributor 28 and/or the distributor's downline 24. Thus, a distributor 28 is required to meet the second volume requirement in each product category before being compensated under the second part of the compensation system in that category. For example, in a certain compensation period a distributor may have 170 PV. The first 50 PV of this 170 PV is counted toward his/her first volume requirement. The remaining 120 PV in additional PV may include, for example, 40 PV in each of several product categories 56. In this instance, the distributor 28 will not qualify for compensation under the second part of the compensation system in any category, since he/she did not have 100 PV in any category. In contrast, in a similar example, after the first volume requirement is met, the distributor's remaining 120 PV consists of 110 PV in Category A, 5 PV in Category B, and 5 PV in Category C. In this instance, the distributor 28 qualifies for compensation under the second part of the compensation system in Category A, but not in Categories B or C.

In some embodiments, when a customer 26 has PV over the first volume requirement, e.g., 50, the remaining PV will be attributed to the enrolling distributor 28 for the purpose of meeting the second volume requirement and filling the overflow bucket 54. Thus, the PV created each month by a distributor's customers 26 can assist the distributor 28 to qualify to greater compensation under the second part of the compensation system.

Based on the foregoing, it will be understood that a distributor 28 can qualify for compensation under the second part of the compensation system in multiple product categories 56, as the distributor 28 meets the second volume requirement for each product category 56.

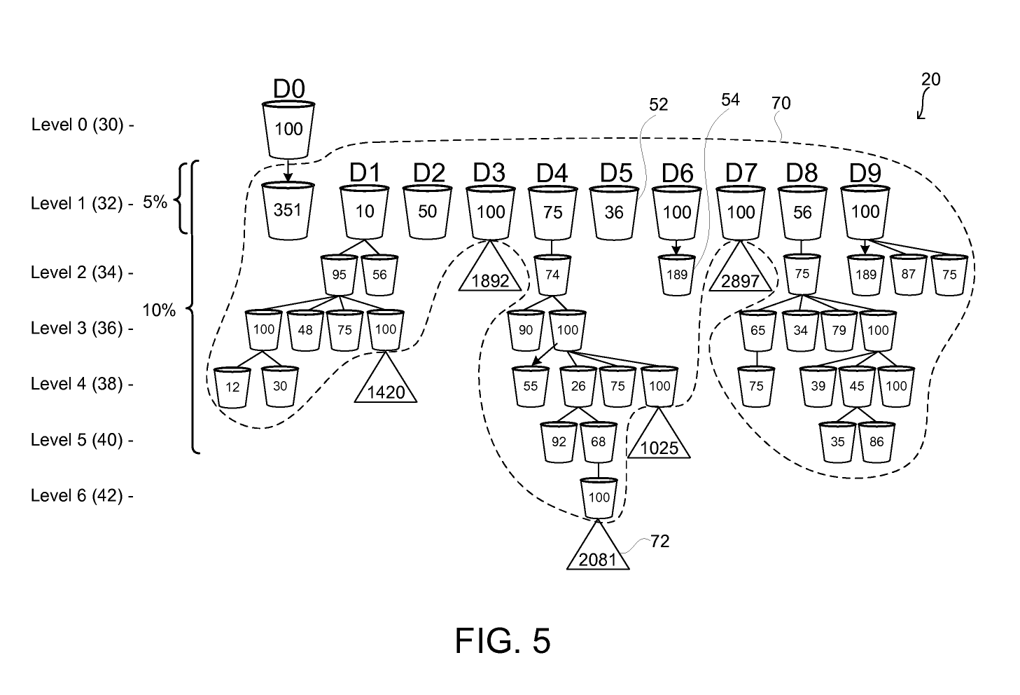

Reference will now be made to FIG. 3, which depicts specific embodiments of the first part of the compensation system. The Figure specifically illustrates a system of compensating Level 0 (32) distributor, D0. The Figure further illustrates the members of a network marketing organization 20 in D0's downline 24 who have PV which meet the first volume requirement. This requirement is illustrated as a 50 PV bucket labeled “50”. In this Figure, Distributor D0 is has 10 members in his/her frontline 32 who have met the first volume requirement. These members include four customers C1-C4 and six distributors D1-D6. Moreover, distributor D2 has six members in his/her downline that have met the first volume requirement. Similarly, D3 has two members in his/her downline that have met the first volume requirement. D4 has three. D5 has three. D6 has one. For simplicity of illustration, in this example the downlines of distributors D2-D6 are only one leg wide, though these downlines can be multiple legs wide, as shown in FIG. 5. The width of a downline, as used herein, refers to the number of members in a single level. Similarly, the depth of a downline, as used herein, refers to the number of levels down to which the downline goes.

In some embodiments of the first part of the compensation system, distributor D0 is compensated for the first volume of PV, e.g., the first 50 PV, of each member in his downline who also meets the first volume requirement. This compensation can be a percentage of a price for each PV. As shown, the percentage may vary based on the level of the member in the distributor's downline 24. For example, in some embodiment, the percentage paid on PV of the members in the distributor's frontline can be about 15%. Similarly, the percentage paid on PV of the members in the distributor's second and third level can be about 10%. The percentage paid on PV of the members in the distributor's fourth, fifth, and sixth levels can be about 5%. In some instances, the no compensation is paid on PV below a distributor's sixth level of downline. As illustrated in these examples, higher percentages can be paid in the early levels of the first part of the compensation system. These higher percentages can reward entry-level distributors 28, as opposed reserving higher payouts for distributors with large downlines 24.

Additionally, in some embodiments, distributors 28 are compensated, under the first part of the compensation system up to one level deep in the distributor's downline 24 for each member wide of the distributor's frontline 32 who meets the first volume requirement, capping out at six levels deep. For example, distributor D2 has a frontline width of only member who meets the first volume requirement would only be compensated for up to one level deep in his downline 24 in this first part of the compensation system. Likewise, a hypothetical distributor having five members on his/her frontline 32 who meet the first volume requirement would be compensated for up to five levels deep in his downline 24. Similarly, in the illustrated example, distributor D0 has a frontline 32 with ten members who meet the first volume requirement and can thus be compensated for six levels deep, since six is the maxim levels deep. In other instances, this maximum number of levels can be modified to be, for example, three, four, five, seven, eight, nine, ten, more than ten, or limitless.

In various embodiments of the compensation system, compensation can be paid with compression of non-performing legs. For example, as shown in FIG. 3 in the downline of D5 at level 5 (40) there is a member 62 who met the first volume requirement, but the member 60 in level 4 (38) did not, having only 10 PV. With compression of payments, the member 62 in level 5 (40) who meet the first volume requirement is treated as being in level 4 (38), with member 60 being removed, or compressed, for payment purposes. In some embodiments, this principle of compression can be implemented in the second part of the compensation system as well.

Reference will now be made to more specific embodiments of the second part of the compensation system. The second part of the compensation system can be broken into three subparts, a standard compensation subpart, an executive compensation subpart, and a bonus subpart. The standard compensation subpart is depicted in FIG. 4, and the executive and bonus subparts compensation are depicted in FIG. 5.

Reference will first be made to FIG. 4, which illustrates the sales performance of four distributors 28 of a single product category. These distributors 28 can be the same distributors D0-D3 illustrated in FIG. 1, with distributor D0 being in Level 0 (30) and distributors D1-D3 being in Level 1 (32). In this example, distributor D0 is illustrated as meeting the second volume requirement since his/her second bucket (shown as a 100 bucket) 52 includes 100 PV and is therefore full. Additionally, D0 is illustrated as having an additional 135 PV that has spilled over into the overflow bucket 54. Downline distributor D1 has 10 PV in his/her second bucket 52, distributor D2 has 78, and distributor D3 has 100 PV. Thus, only distributor D3 of the downline distributors met the second volume requirement by having over 100 PV in this product category. As such all additional PV over the 100 spilled over into distributor D3's overflow bucket 54. The amount in this overflow bucket is 245 PV.

Continuing with the example of the standard compensation part shown in FIG. 4, by meeting the second volume requirement in this product category 56, distributor D0 is entitled to be compensated for PV in his/her own overflow bucket 54 and PV in the second buckets 52 of members in his/her downline 24. In some instances, the distributor D0 is not entitled to compensation for PV in the overflow buckets 54 of members in his/her downline 24, such as PV in the overflow bucket 54 of distributor D3. Compensation in the standard compensation part can be a percentage of a price for each PV in each bucket. For instance, as shown, the percentage can be 5%. In other instances, the percentage can be less or more than 5%, such as between 2% or 4% or between 5% and 15%. Furthermore, in some embodiments, this standard compensation part is limited to members in distributor's frontline (32), and does not extend further down the downline 24. In other embodiments, the standard compensation part extends beyond the distributor's frontline (32) to the Level 2 (34), Level 3 (36), and/or beyond Level 3 (36).

Reference will now be made to FIG. 5, which illustrates the executive compensation and bonus subparts of the second part of the compensation system. Reference will first be made to the executive compensation subpart. FIG. 5 illustrates the sales performance of multiple distributors 28 for a single product category. The distributors 28 are illustrated in a network marketing organization 20, having many distributors, each of which can include his/her own downlines, making the downline 24 of D0 to be very large. Specifically, six levels of downline, not including executive downlines 72, which are represented with a triangle, and which will be described below. On D0's frontline, level 1 (32), are nine distributors D1-D9 who have PV in the specific product category that qualify for meeting the second volume requirement. This PV is represented as the number within the second buckets 52 or the overflow buckets 54. A line with an arrow from the second buckets 52 to the overflow buckets 54 distinguishes the overflow buckets 54 from the second buckets 52. Similarly, a simple line with no arrow indicates a downline relationship.

Generally, the executive compensation subpart compensates a distributor 28 for sales in the product category made by members in the distributor's downline when the entire volume of PV of the product category made by members in the distributor's downline exceeds a certain volume. This certain volume can be referred to as the third volume requirement. The third volume requirement can be for example 1,000 PV. In other instances, the volume is between about 250 PV and about 10,000 PV, such as between about 250 PV and about 500 PV, about 500 PV and about 1,000 PV, about 1,000 PV and about 2,500 PV, about 2,500 PV and about 5,000 PV, about 5,000 PV and about 7,500 PV, or about 7,500 PV and about 10,000 PV. For non-limiting illustration purposes, the number 1,000 PV will be used as the third volume requirement.

Turning to the details of FIG. 5, all of the buckets counting towards the third volume requirement of D0 are enclosed within a dotted line 70. These buckets within the dotted line 70 represent the entire volume of PV of the product category excluding PV made in the downline 72 of an executive distributor. Because the sum of PV in each of these buckets adds up to more than 1,000 distributor D0 meets the third volume requirement and is entitled to a percentage of these sales. In some embodiments, this percentage is about 10%, as shown. In other embodiments, this percentage is between 5% and 20%. Because distributor D0 met the third volume requirement, distributor D0 can also be considered an executive. If distributor D0 meets the third volume requirement for multiple product categorize, e.g., five categories, distributor D0 can be referred to a multiple star executive, e.g., a five star executive.

It will be noted, that because the executive compensation subpart begins to pay on the frontline 32, the distributor D0 is paid twice for this frontline 32, a first time in the standard compensation subpart and a second time in the executive compensation subpart. Thus, if the standard compensation subpart provides a 5% payment on the frontline 32 and the executive compensation subpart provides an additional 10% payment on the frontline 32, the distributor 28 is paid a total 15% on the frontline 32 and 10% on the remaining downline.

Reference will now be made to the bonus subpart of the second part of the compensation system. In some instances, the bonus subpart is provided only to executive distributors, while in other instances, non-executive distributors can also participate, if they meet the second volume requirement. Those who participate in the bonus subpart will be referred to as qualifying distributors. As with the other subparts of the second part of the compensation system, the bonus subpart only relates to products in a specific product category. Accordingly, a distributor 28 may qualify for the bonus subpart in multiple categories.

Generally, the bonus subpart pays out of a bonus pool. The bonus pool is a percentage of the entire sum of money received for PV of a particular product in the network marketing organization 20. For example, if a $1,000,000 was received for sales of products in a specific product category, Category A, 56 throughout the entire network marketing organization 20, then a percentage of this sum can be available in a bonus pool. This percentage can be, for example, about 30%. Other non-limiting examples of bonus percentages include about 5%, about 10%, about 15%, about 20%, about 25%, about 35%, about 45%, or about 50%. For illustration purposes, 30% will be used in the following examples as the bonus percentage. Continuing the previous example, with $1,000,000 in sales from a Category A, the bonus pool for Category A is 30% of that amount, or $300,000.

Each qualifying distributor can be paid a portion of the bonus pool according to the ratio of PV attributable to each distributor over the sum of all PV attributable to qualifying distributors. This ratio can be referred to as the distributor's contribution ratio. This contribution ratio is multiplied by the entire bonus pool to determine the distributor's bonus compensation. This compensation can be seen in Formula 1, below:

Qualifying distributor bonus compensation=(PV attributable to the qualifying distributor/Sum of all PV attributable to all qualifying distributors)×Bonus pool

For example, continuing with the previous example, if a qualifying distributor's contribution ratio is 1/100, his/her bonus compensation would be 1/100 multiplied by the bonus pool of $300,000. Thus, the qualifying distributor's bonus compensation would be $3,000.

PV attributable to each qualifying distributor can include all PV that can be used to determine if the distributor met the third volume requirement plus PV in the qualifying distributor's second bucket 52. This includes the entire sum of PV of a particular product category, excluding those counted in the first volume requirement, in the qualifying distributor's second bucket 52 and overflow bucket 54 and PV of members of the qualifying distributor's downline in their second buckets 52 and their overflow buckets 54, excluding the downline 72 of executive distributors.

However, in some instances, at least some of the downline 72 of downline executive distributors can be included in the qualifying distributor's tally of PV attributable to that qualifying distributor. In some embodiments, PV attributable to each qualifying distributor can include the downline of executive distributors in the qualifying distributor's downline up to one level deep in the executive distributor's downline for every executive leg in the distributor's downline, up to a certain limit (e.g., up to 3, 4, 5, 6, 7, 8, 9, or 10 levels deep). In some configurations, For example, referring to FIG. 5, in distributor D0's downline there are five executive distributors with executive downlines 72. These executive downlines 72 are represented with triangle that show the number of PV made in that downline. Thus, in the example of FIG. 5, PV attributable to distributor D0 could include all of the sales made in the first five levels of executive downlines 72 of executives in D0's downline 24.

The identification and calculation of PV attributable to each qualifying distributor is made for each qualifying distributor. Subsequently, the sum of all PV attributable to all qualifying distributors is identified and calculated. It will be noted, that some PV may be attributable to multiple distributors. For example, PV made in Level 2 (34) may be attributable to a distributor in Level 1 (32) and a distributor in Level 0 (30). Thus, the total sum of all PV attributable to all qualifying distributors may be larger than the sum of all sales.

A simplified example of the bonus compensation part can be demonstrated by reference to FIG. 4. In this example, the entire volume of qualifying PV is 668 PV, which is computed by adding all of the PV in each bucket (which is thus calculated by adding 100 PV+135 PV+10 PV+78 PV+100 PV+245 PV). Assuming, for the sake of example, that each PV had a price of $1, the entire sum of money received for the PV of these particular product in the network marketing organization is $668. If the bonus percentage is 30%, the bonus pool is then $200.40 (which is calculated by taking 30% of $668).

Continuing still with the example of FIG. 4, as mentioned, of the four distributors 28 shown, only two meet the second volume requirement and are therefore qualifying distributors. These two qualifying distributor are distributor D0 and distributor D3. The PV attributable to distributor D0 include all of the PV shown, which sum to 668 PV. The PV attributable to D3 is 345 PV (which is computed by adding 100 PV+245 PV). Sum of all PV attributable to all qualifying distributors is thus 1,013 PV. As noted above, this exceeds the total number of sales, which is only 668 PV. Using the formula described above, the contribution ratio of distributor D0 is 668 PV/1,013 PV=about 0.66. Similarly, the contribution ratio of distributor D3 is 345 PV/1,013 PV=about 0.34. Each qualifying distributor is then compensated by multiplying the bonus pool ($200.40) by his/her contribution ratio. Accordingly, distributor D0 is compensated about $132.26 and distributor D3 is compensated about $68.14. In this manner, the bonus compensation part of a network marketing organization 20 can be identified and calculated.

Thus, in summary, as discussed herein, embodiments the present invention embrace compensation systems and methods. In some embodiments, the compensation system involves multiple parts, creating a progressive pay compensation in which the distributor is paid a percentage of PV in the distributor's downline when the quantity of PV by the distributor and/or his/her downline reach a set of predetermined thresholds. These compensation system embodiments can provide a win-win situation for both part-time distributor (the masses) as well as executive distributors and multi-star executive distributors. Furthermore, because compensation is eventually broken down in to product categories, distributors can qualify for compensation in multiple product categories. This system can thus increase the likelihood of overall sales volume increase with the introduction of new products categories.

### Representative Operating Environment

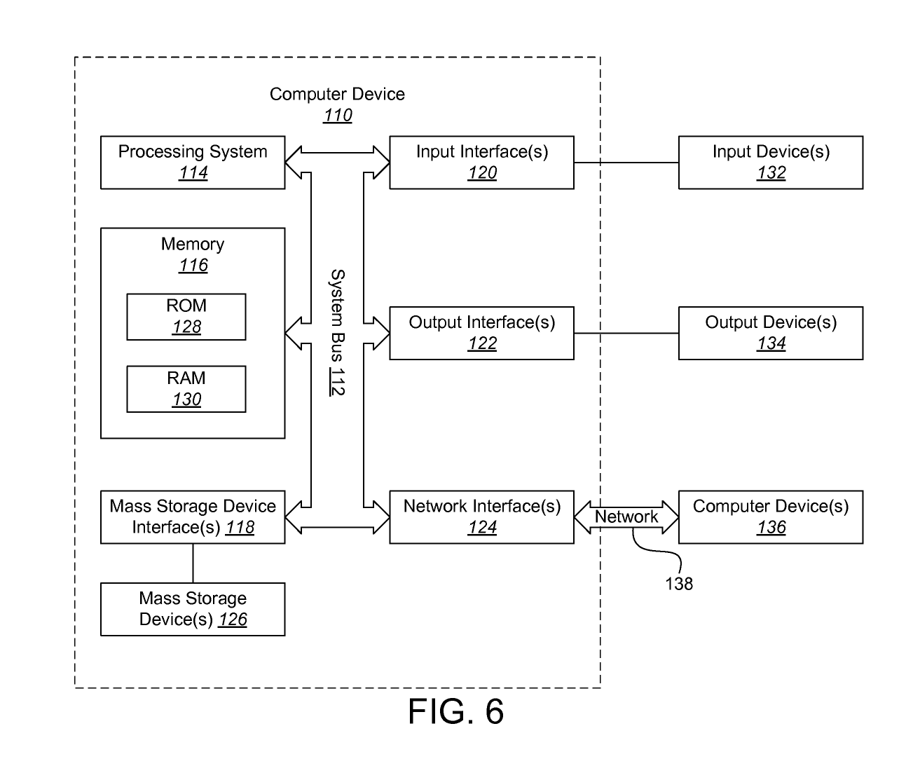

Reference will now be made to FIG. 6 and the corresponding discussion, which are intended to provide a general description of a suitable operating environment in which embodiments of the compensation systems and methods may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 6, a representative system for implementing embodiments of the invention includes computer device 110, which may be a general-purpose or special-purpose computer or any of a variety of consumer electronic devices. For example, computer device 110 may be a personal computer, a notebook computer, a netbook, a tablet computer, a personal digital assistant (“PDA”), a smart phone, or other hand-held device, a workstation, a minicomputer, a mainframe, a supercomputer, a multi-processor system, a network computer, a processor-based consumer electronic device, or the like.

Computer device 110 includes system bus 112, which may be configured to connect various components thereof and enables data to be exchanged between two or more components. System bus 112 may include one of a variety of bus structures including a memory bus or memory controller, a peripheral bus, or a local bus that uses any of a variety of bus architectures. Typical components connected by system bus 112 include processing system 114 and memory 116. Other components may include one or more mass storage device interfaces 18, input interfaces 120, output interfaces 122, and/or network interfaces 124, each of which will be discussed below.

Processing system 114 includes one or more processors, such as a central processor and optionally one or more other processors designed to perform a particular function or task. It is typically processing system 114 that executes the instructions provided on computer-readable media, such as on memory 116, a magnetic hard disk, a removable magnetic disk, a magnetic cassette, an optical disk, or from a communication connection, which may also be viewed as a computer-readable medium.

Memory 116 includes one or more computer-readable media that may be configured to include or includes thereon data or instructions for manipulating data, and may be accessed by processing system 114 through system bus 112. Memory 116 may include, for example, ROM 128, used to permanently store information, and/or RAM 130, used to temporarily store information. ROM 128 may include a basic input/output system (“BIOS”) having one or more routines that are used to establish communication, such as during start-up of computer device 110. RAM 130 may include one or more program modules, such as one or more operating systems, application programs, and/or program data.

One or more mass storage device interfaces 118 may be used to connect one or more mass storage devices 126 to system bus 112. The mass storage devices 126 may be incorporated into or may be peripheral to computer device 110 and allow computer device 110 to retain large amounts of data. Optionally, one or more of the mass storage devices 126 may be removable from computer device 110. Examples of mass storage devices include hard disk drives, magnetic disk drives, tape drives and optical disk drives. A mass storage device 126 may read from and/or write to a magnetic hard disk, a removable magnetic disk, a magnetic cassette, an optical disk, or another computer-readable medium. Mass storage devices 126 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 120 may be employed to enable a user to enter data and/or instructions to computer device 110 through one or more corresponding input devices 132. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 120 that may be used to connect the input devices 132 to the system bus 112 include a serial port, a parallel port, a game port, a universal serial bus (“USB”), an integrated circuit, a firewire (IEEE 1394), or another interface. For example, in some embodiments input interface 120 includes an application specific integrated circuit (ASIC) that is designed for a particular application. In a further embodiment, the ASIC is embedded and connects existing circuit building blocks.

One or more output interfaces 122 may be employed to connect one or more corresponding output devices 134 to system bus 112. Examples of output devices include a monitor or display screen, a speaker, a printer, a multi-functional peripheral, and the like. A particular output device 134 may be integrated with or peripheral to computer device 110. Examples of output interfaces include a video adapter, an audio adapter, a parallel port, and the like.

One or more network interfaces 124 enable computer device 110 to exchange information with one or more other local or remote computer devices, illustrated as computer devices 136, via a network 138 that may include hardwired and/or wireless links. Examples of network interfaces include a network adapter for connection to a local area network (“LAN”) or a modem, wireless link, or other adapter for connection to a wide area network (“WAN”), such as the Internet. The network interface 124 may be incorporated with or peripheral to computer device 110. In a networked system, accessible program modules or portions thereof may be stored in a remote memory storage device. Furthermore, in a networked system computer device 110 may participate in a distributed computing environment, where functions or tasks are performed by a plurality of networked computer devices.

Those skilled in the art will appreciate that embodiments of the present invention embrace a variety of different system configurations. For example, in one embodiment the system configuration includes an output device (e.g., a multifunctional peripheral (MFP) or other printer/plotter, a copy machine, a facsimile machine, a monitor, etc.) that performs multi-colorant rendering. In another embodiment, the system configuration includes one or more client computer devices, optionally one or more server computer devices, and a connection or network communication that enables the exchange of communication to an output device, which is configured to perform multi-colorant rendering.

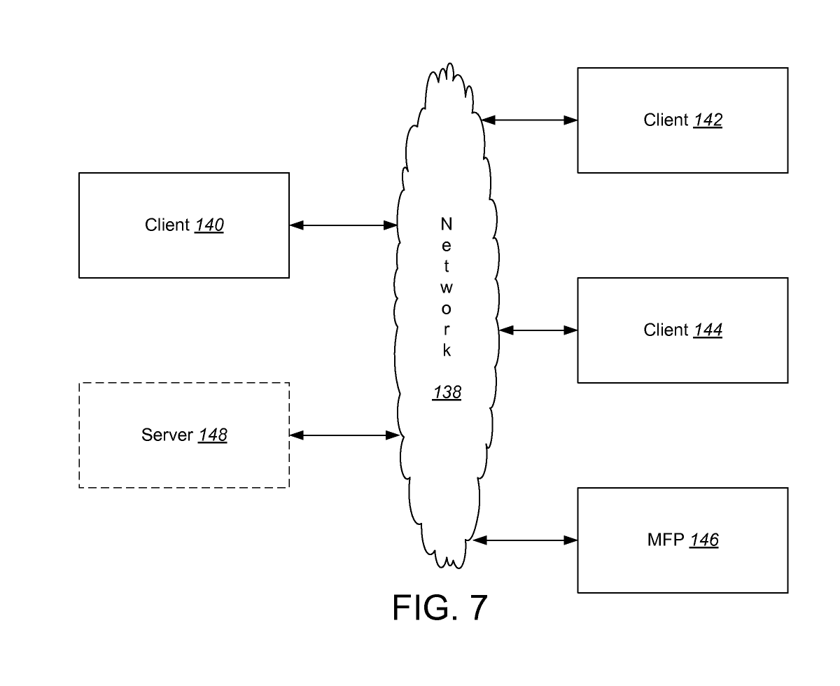

Thus, while those skilled in the art will appreciate that embodiments of the present invention may be practiced in a variety of different environments with many types of system configurations, FIG. 7 provides a representative networked system configuration that may be used in association with embodiments of the present invention. The representative system of FIG. 7 includes a computer device, illustrated as client 140, which is connected to one or more other computer devices (illustrated as client 142 and client 144) and one or more peripheral devices (illustrated as multifunctional peripheral (MFP) MFP 146) across network 138. While FIG. 7 illustrates an embodiment that includes a client 140, two additional clients, client 142 and client 144, one peripheral device, MFP 146, and optionally a server 148, which may be a print server, connected to network 138, alternative embodiments include more or fewer clients, more than one peripheral device, no peripheral devices, no server 148, and/or more than one server 148 connected to network 138. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 7, the client 140 may be a computer device having a limited set of hardware and/or software resources. Because the client 140 is connected to the network 138, it may be able to access hardware and/or software resources provided across the network 138 by other computer devices and resources, such as client 142, client 144, server 148, or any other resources. The client 140 may access these resources through an access program, such as a web browser, and the results of any computer functions or resources may be delivered through the access program to the user of the client 140. In such configurations, the client 140 may be any type of computer device or electronic device discussed above or known to the world of cloud computing, including traditional desktop and laptop computers, smart phones and other smart devices, tablet computers, or any other device able to provide access to remote computing resources through an access program such as a browser.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for compensating distributors in a network marketing system, the method being performed by a computer system comprising at least one processor and at least one non-transitory computer readable medium encoded with program instructions that, when executed, cause the system to perform the method, the method comprising identifying, by the at least one processor, and compensating a distributor based on a progressive pay compensation in which the distributor is paid a percentage of personal volume (PV) in the distributor's downline when the quantity of PV by the distributor and the distributor's downline reach a set of predetermined thresholds.

2. A method for compensating a distributor in a network marketing system, the method being performed by a computer system comprising at least one processor and at least one non-transitory computer readable medium encoded with program instructions that, when executed, cause the system to perform the method, the method comprising:
identifying, by the at least one processor, and compensating a distributor for PV of individual members of the distributor's downline that amounted to at least a first volume when the distributor has PV of at least the first volume; and
identifying, by the at least one processor, and compensating the distributor for PV of individual members in the distributor's downline of a particular product when the distributor has PV of the particular product of at least a second volume, wherein the PV of the distributor and members in the distributor's downline counted in the first volume are not included in the second volume.

3. The method of claim 2, wherein the first volume is a volume of fifty PV during a predetermined time period.

4. The method of claim 2, wherein the PV of individual members of the distributor's downline that amounted to at least a first volume are a first set of PV, and wherein compensating the distributor for the first set of PV includes compensating the distributor a percentage of a price for each PV in the first set of PV, wherein the percentage is based on the level in the distributor's downline of the members having PV.

5. The method of claim 4, wherein the percentage of the price for members in the distributor's frontline is about 15%, wherein the percentage of the price for members in the distributor's second level is about 10%, wherein the percentage of the price for members in the distributor's third level is about 10%, wherein the percentage of the price for members in the distributor's fourth level is about 5%, wherein the percentage of the price for members in the distributor's fifth level is about 5%, wherein the percentage of the price for members in the distributor's sixth level is about 5%, and wherein the percentage of the price for members in the distributor's seventh level and lower is about 0%.

6. The method of claim 4, wherein compensating the distributor for the first set of PV includes compensating the distributor for up to one level deep, to a predetermined maximum depth, in the distributor's downline for each member wide of the distributor's frontline that includes a member PV of the first volume.

7. The method of claim 2, wherein the second volume is a volume of one hundred PV during a predetermined time period.

8. The method of claim 2, wherein the PV of individual members in the distributor's downline of a particular product not counted in the first volume are a second set of PV, and wherein compensating the distributor for the second set of PV includes compensating a distributor for the second set of PV in the product category of members in the distributor's frontline only.

9. The method of claim 8, wherein compensating the distributor for the second set of PV further includes compensating the distributor a percentage of a price for each PV in the product category during a predetermined time period.

10. The method of claim 9, wherein the percentage is about 5%.

11. The method of claim 2, further comprising identifying, by the at least one processor, and compensating the distributor for PV in the product category of members in the distributor's downline when the entire volume of PV of the product category of members in the distributor's downline exceeds a third volume.

12. The method of claim 11, wherein the third volume is about 1000 PV.

13. The method of claim 11, wherein the entire volume of PV of the product category of members in the distributor's downline does not include the volume of PV in the downline of an executive distributor in the distributor's downline.

14. The method of claim 11, wherein compensating the distributor for PV in the product category of members in the distributor's downline when the entire volume of PV of the product category includes compensating the distributor a percentage of the entire volume of PV of members in the distributor's downline.

15. The method of claim 14, wherein the percentage of the entire volume of PV of members in the distributor's downline about 10%.

16. The method of claim 2, further identifying, by the at least one processor, and compensating the distributor based on the ratio of PV attributable to the distributor over entire company PV in the network marketing system, wherein the PV attributable to the distributor include the entire volume of PV of the product category of the distributor and members in the distributor's downline, which includes PV in the downline of an executive distributor in the distributor's downline.

17. The method of claim 16, wherein the included PV in the downline of an executive distributor in the distributor's downline are PV of up to one level deep in the executive distributor's downline for each executive leg in the distributor's downline.

18. The method of claim 16, wherein compensating the distributor based on the ratio of PV attributable to the distributor includes compensating the distributor based on the ratio multiplied by a bonus pool, the bonus pool including the a bonus percentage of the overall PV income for the product category in the network marketing organization but not excluding PV income for those products counted in the first set of PV.

19. The method of claim 18, wherein the bonus percentage is about 30%.

20. A non-transitory computer readable medium encoded with a computer program product loadable into a memory of at least one computer and comprising software code portions for performing the method of claim 2.

21. A system for compensating a distributor in a network marketing system for performing the method of claim 2.
